(19) United States
(12) Patent Application Publication
(10) Pub. No.: US 2024/0391103 A1
(43) Pub. Date: Nov. 28, 2024

(54) MOBILE ROBOT-BASED HIGH TRANSFER EFFICIENCY VEHICLE PAINTING SYSTEM

(71) Applicant: GM GLOBAL TECHNOLOGY OPERATIONS LLC, Detroit, MI (US)

(72) Inventors: John Patrick SPICER, Plymouth, MI (US); Xiang ZHAO, Novi, MI (US); Hua-tzu FAN, Troy, MI (US); Miguel Arturo SAEZ, Clarkston, MI (US); Jorge F. ARINEZ, Rochester Hills, MI (US)

(21) Appl. No.: 18/322,260

(22) Filed: May 23, 2023

(51) Int. Cl. B25J 9/16; B25J 11/00; B25J 15/00

(52) U.S. Cl. CPC B25J 9/1669; B25J 9/162; B25J 9/1697; B25J 11/0075; B25J 15/0019

(57) ABSTRACT

A painting system includes a mobile robot including a frame, wheels connected to the frame, and a motor configured to move the wheels to position the mobile robot. A paint container is mounted on the mobile robot and configured to store paint. A robot arm includes a first end mounted on the mobile robot and a paint applicator arranged at a second end of the robot arm. The paint applicator is in fluid communication with the paint container and includes one or more nozzles to spray the paint onto a surface.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to painting systems, and more particularly to mobile robot-based painting systems.

Vehicles include a body having complex exterior surfaces that are designed to have an aesthetic appeal to consumers. During production of the vehicle, the complex exterior surfaces of the body are painted. After painting, components such as a propulsion system (e.g., an engine or electric motor), windows, interior components (e.g., seats, carpet, interior trim, instrument panel), and/or other components are assembled onto the body.

### SUMMARY

A painting system includes a mobile robot including a frame, wheels connected to the frame, and a motor configured to move the wheels to position the mobile robot. A paint container is mounted on the mobile robot and configured to store paint. A robot arm includes a first end mounted on the mobile robot and a paint applicator arranged at a second end of the robot arm. The paint applicator is in fluid communication with the paint container and includes one or more nozzles to spray the paint onto a surface.

In other features, the paint applicator comprises one of an overspray-free paint applicator and a high transfer efficiency paint applicator. The surface corresponds to a surface of a vehicle. The mobile robot includes a controller configured to control movement of at least one of the mobile robot, the robot arm, and the paint applicator.

In other features, a vision guidance system is configured to communicate with the controller, to take at least one of images and video of the surface, and to determine a position of at least one of the mobile robot, the robot arm, and the paint applicator based on the at least one of images and video of the surface. The controller positions the at least one of the mobile robot, the robot arm, and the paint applicator in response to the vision guidance system.

In other features, the surface corresponds to a surface of a vehicle and further comprising an end effector configured to manipulate a component of the vehicle. The controller is configured to control a position of the end effector. The end effector includes an arm configured to move a swing panel of the vehicle. The paint applicator includes a plurality of nozzles and a plurality of actuators configured to adjust positions of the plurality of nozzles, respectively, relative to the paint applicator. The controller is configured to adjust positions of the plurality of actuators, respectively.

A painting system for a vehicle includes G groups of mobile robots each including a paint applicator, where G is an integer greater than zero, wherein each of the G groups includes two or more mobile robots configured to paint a respective one of G paint colors. A first controller is configured to determine a first color of a first surface to be painted; select R of the mobile robots in a first one of the G groups corresponding to the first color, where R is an integer greater than zero and less than or equal to G; assign R portions of the first surface to the R mobile robots of the first one of the G groups, respectively; and send R sets of instructions to the R mobile robots of the first one of the G groups, respectively, to paint the R portions of the first surface.

In other features, the first controller is configured to communicate with the R mobile robots of the first one of the G groups during painting of the first surface and to at least one of replace at least one of the R mobile robots with another mobile robot from the first one of the G groups when the at least one of the R mobile robots has a malfunction and adjust at least one of the R portions of the first surface and send revised instructions based on the adjustment.

In other features, the first controller is further configured to determine a second color of a second surface to be painted after the first surface, where the second color is different than the first color; select S of the mobile robots of a second one of the G groups corresponding to the second color, where S is an integer greater than zero and less than or equal to G; assign S portions of the second surface to be painted to the S mobile robots of the second one of the G groups; and send S sets of instructions to the S mobile robots of the second one of the G groups, respectively, to paint S corresponding portions of the second surface.

In other features, each of the mobile robots includes a frame; wheels connected to the frame; a motor configured to move the wheels to position the mobile robot; a paint container mounted on the mobile robot and configured to store paint; and a robot arm including a first end mounted on the mobile robot and a paint applicator arranged at a second end of the robot arm. The paint applicator is in fluid communication with the paint container and includes one or more nozzles to spray the paint onto the first surface.

In other features, the paint applicator comprises one of an overspray-free paint applicator and a high transfer efficiency paint applicator, and the first surface corresponds to a surface of a vehicle. The paint applicator includes a plurality of nozzles and a plurality of actuators configured to adjust positions of the plurality of nozzles, respectively. Each of the mobile robots includes a second controller configured to control movement of at least one of the mobile robot, the robot arm, and the paint applicator.

In other features, a vision guidance system is configured to communicate with the second controller, to take at least one of images and video of the first surface, and to determine a position of at least one of the mobile robot, the robot arm, and the paint applicator based on the at least one of images and video of the first surface. The second controller is configured to position the at least one of the mobile robot, the robot arm, and the paint applicator in response to the vision guidance system.

In other features, the first surface corresponds to a surface of a vehicle and further comprising an end effector including an arm. The second controller is configured to control a position of the arm of the end effector to manipulate a swing panel of the vehicle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view illustrating an example of a painting system including mobile robots according to the present disclosure;

FIGS. 2A and 2B are side and plan views of an example of a multi-nozzle paint applicator according to the present disclosure;

FIG. 3 is a front view illustrating an example of a painting system including mobile robots with a multi-nozzle paint applicator according to the present disclosure;

FIG. 4 is a front view illustrating an example of a painting system including mobile robots with a paint applicator and a vision guidance system according to the present disclosure;

FIGS. 5A and 5B are front views illustrating an example of a painting system including mobile robots with a paint applicator and an end effector according to the present disclosure;

FIGS. 6 and 7 are functional block diagrams of examples of painting systems including groups of robots with paint applicators according to the present disclosure; and

FIG. 8 is a flowchart of an example of a method for operating a painting system including groups of robots with paint applicators according to the present disclosure.

In the drawings, reference numbers may be reused to identify similar and/or identical elements.

### DETAILED DESCRIPTION

While a painting system according to the present disclosure is being described below in the context of painting bodies of vehicles, the painting system can be used to paint surfaces in non-vehicular applications. Examples of non-vehicular applications include painting lines on sports fields, lines on roads, interiors and/or exteriors of large buildings, etc.

Overspray-free paint applicators or high transfer efficiency applicators require little or no masking and are primarily used for decorative painting of vehicles (e.g., stripes on a vehicle). Standard paint applicators have a transfer efficiency of about 70%. Overspray-free paint systems have a transfer efficiency around 100%. As used herein, high transfer efficiency applicators have a transfer efficiency greater than 90%.

The painting system according to the present disclosure includes one or more mobile robots each including a robot arm with an overspray free paint applicator or a high transfer efficiency paint applicator and a paint container to supply paint to the paint applicator. The paint applicator includes one or more nozzles.

In some examples, a single mobile robot is used to paint the vehicle and the paint container is configured to store paint for a portion of a vehicle, an entire vehicle, and/or multiple vehicles. In some examples, the mobile robots include a vision guidance system configured to position the robot arm and/or the paint applicator relative to the vehicle. In some examples, the mobile robot includes an end effector to allow manipulation of a component of the vehicle. In some examples, the end effector is used to manipulate a swing panel, such as a door, a hood, a truck lid, a liftgate, etc., before, during or after applying paint. The swing panel can be moved to allow paint to be applied to the swing panel and/or to the body.

In some examples, a group of the mobile robots is used to paint a single vehicle. In some examples, the mobile robots are dynamically added and/or removed from the group of the mobile robots during the painting operation. When multiple mobile robots are used to paint a single vehicle, a controller divides surface areas of the vehicle that need to be painted and assigns each of the mobile robots to specific surface areas. In some examples, the controller and/or the mobile robots coordinate their positions and/or travel paths to avoid collision in the paint area and/or in areas around the paint area.

When the next vehicle to be painted requires a different paint color than the prior vehicle, the mobile robots with the prior paint color are replaced by mobile robots having the paint color for the next vehicle. In other words, one or more mobile robots with the desired paint color are dispatched to the painting area (e.g., a station/booth) and one or more mobile robots with the prior paint color leave the painting area. This approach avoids the need to purge paint from the paint applicators, which can be time consuming and/or cause quality issues.

When one of the mobile robots needs service (e.g., malfunctions, runs out of paint during a paint job, experiences a component failure, etc.), a replacement mobile robot is assigned to the group to continue the paint operation while the malfunctioning mobile robot is taken offline and removed from the paint area for maintenance or repair. As a result, downtime can be significantly reduced.

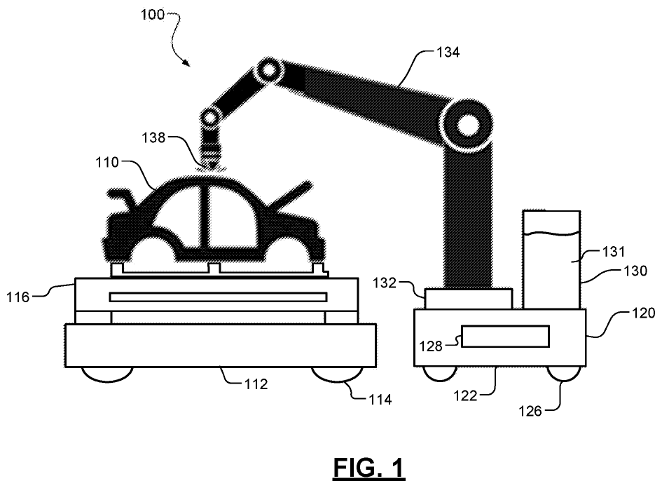

Referring now to FIG. 1, a painting system 100 includes a mobile robot 120 that is configured to paint a vehicle 110. The vehicle 110 is arranged on a cart 112 including wheels 114 and one or more supporting frames and/or fixtures 116 to support the vehicle 110. The cart 112 can be self-propelled, attached to a conveyor system, or attached to other carts 112 and a propulsion source.

The mobile robot 120 includes a frame 122 including wheels 126 and one or more motors 128. The motors 128 position the mobile robot 120 within the paint area and/or move the mobile robot to/from the paint area, a maintenance area, a paint refill area, and/or other locations. The frame 122 supports a paint storage container 130 configured to store paint 131.

A base support 132 is arranged on the frame 122 to support a robot arm 134. In some examples, the robot arm 134 moves the paint applicator with six degrees of freedom including X axis, Y axis, Z axis, pitch, yaw, and roll. The robot arm 134 can be fixed or rotatably attached to the base support 132. An end of the robot arm 134 is attached to a paint applicator 138 that has a high transfer efficiency. While a single robot is shown, the painting system 100 can use one or more mobile robots to paint a surface of a vehicle (or other surfaces such as painting lines on sports fields, lines on roads, interiors and/or exteriors of large buildings, etc.). While the paint applicator 138 is shown with a single nozzle, multiple nozzles can be used. The mobile robots 120 may include a battery to supply power or a wired connection to a power source can be used (both not shown).

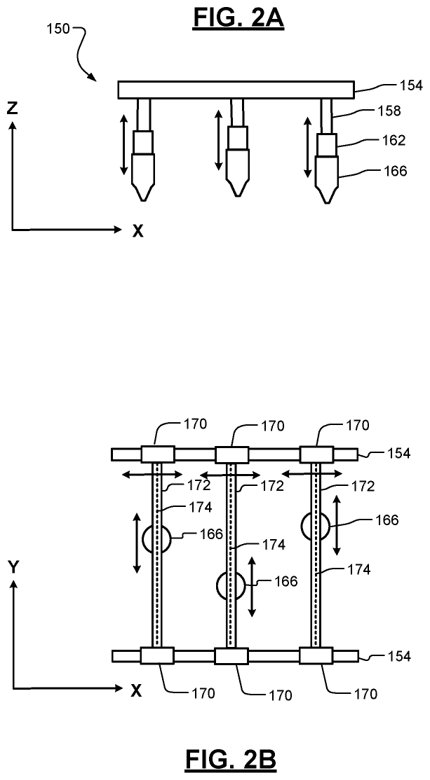

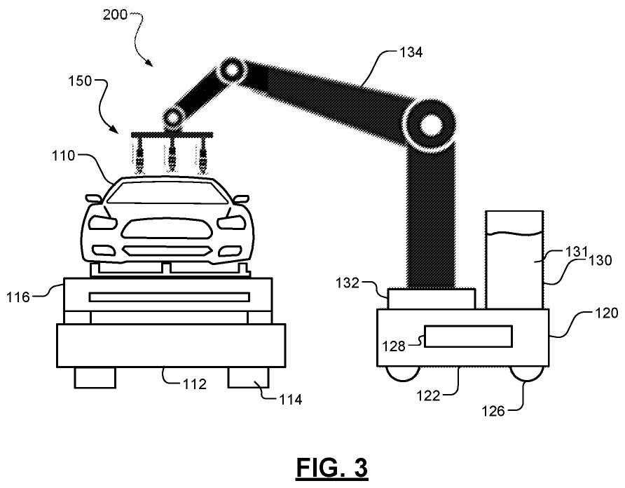

Referring now to FIGS. 2A to 3, a multi-nozzle paint applicator 150 is shown. In FIG. 2A, the multi-nozzle paint applicator 150 includes first horizontal supports 154 and vertical supports 158. Nozzles 166 are connected to the vertical supports 158. In some examples, manual vertical adjusters and/or vertical actuators identified at 162 allow the nozzles 166 to move (or be manually moved) reciprocally in a vertical direction relative to the vertical supports 158.

In FIG. 2B, second horizontal supports 172 extend between the first horizontal supports 154 and are moved by manual adjusters or actuators identified at 170 relative to the first horizontal supports 154. The vertical supports 158 extend downwardly from the second horizontal supports 172. In some examples, adjusters or actuators identified at 174 move the vertical supports 158 relative to the second horizontal supports 172. In FIG. 3, a painting system 200 includes the mobile robot 120 with the multi-nozzle paint applicator 150 attached to an end of the robot arm 134.

In some examples, each of the nozzles 166 can be adjusted or actuated in X, Y and Z directions to accommodate different contours and/or curves of the body surfaces of the vehicle to be painted. As can be appreciated, positioning of the nozzles 166 can be performed manually or using actuators.

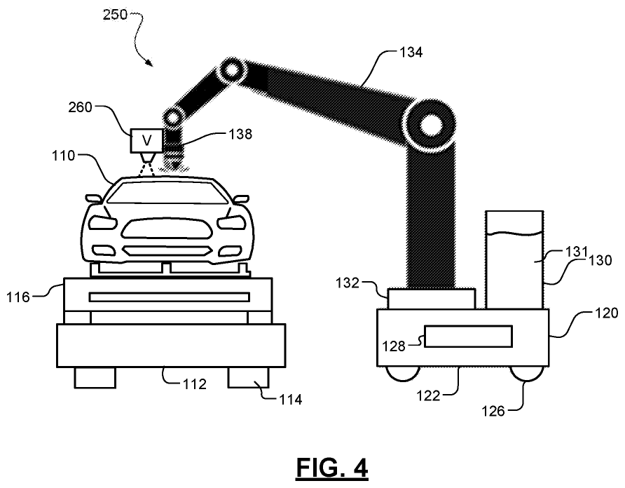

Referring now to FIG. 4, a painting system 250 includes the mobile robot 120 with a vision guidance system 260 attached to an end of the robot arm 134. While the mobile robot is shown with a paint applicator having a single nozzle, a multiple-nozzle paint applicator can be used. The vision guidance system 260 takes images or video of portions of the vehicle and/or an environment to position the mobile robot and/or the nozzle relative to the a surface to be painted to increase the precision of paint spraying. The vision guidance system 260 may also be used during travel to/from the paint area, a paint refilling area, and/or a maintenance area.

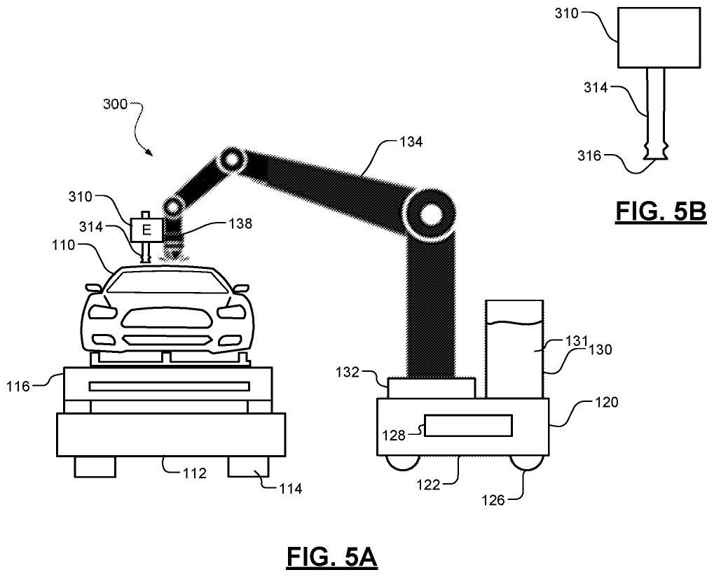

Referring now to FIGS. 5A and 5B, a painting system 300 includes the mobile robot 120 with an end effector 310. In some examples, the end effector 310 includes an arm 314 attached to an end of the robot arm 134. The arm 314 of the end effector 310 can be extended, retracted and/or positioned in X, Y, or Z directions using the robot arm 134 to manipulate a swing panel such as a door, a hood, a trunk lid, a lift gate, or other panel of the vehicle. While the end effector 310 is shown with a suction cup 316 as an example, the end effector 310 may include other types of actuators and/or other mechanisms. In FIG. 5A, the arm 314 of the end effector 310 is retracted, In FIG. 5B, the arm 314 of the end effector 310 is extended. In addition, the arm 314 can be positioned using the robot arm 134.

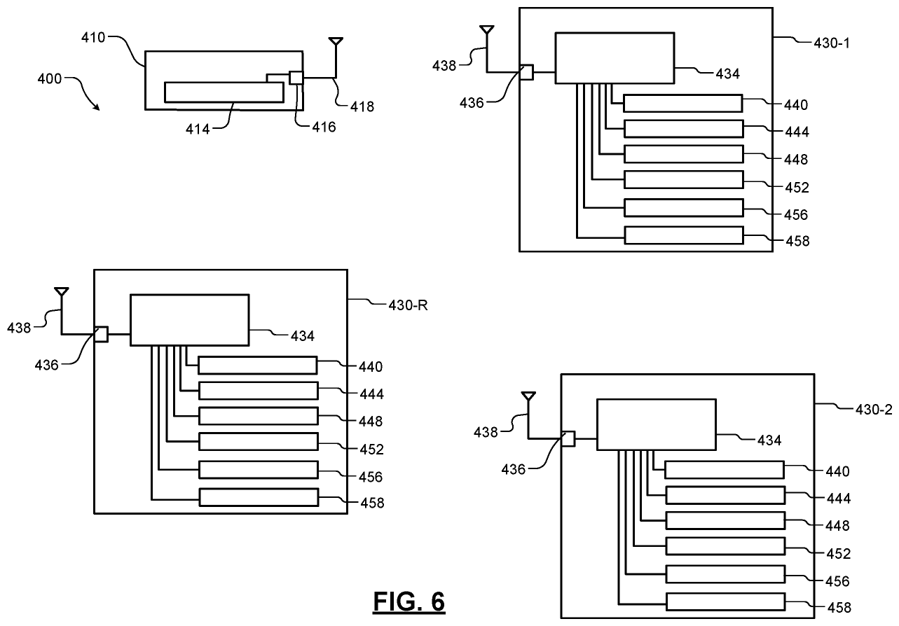

Referring now to FIG. 6, a painting system 400 includes a controller 410 and R robots 430-1, 430-2, . . . , and 430-R, where R is an integer greater than one. The controller 410 further includes a robot coordinating module 414 configured to coordinate work performed by the R robots 430. In some examples, the controller 410 and the R robots 430 communicate wirelessly and the controller 410 includes a wireless interface 416 and an antenna 418. In other examples, the controller 410 and the R robots 430 are directly connected and include a wired interface.

The R robots 430 further include a controller 434, a paint arm 440, a vision guidance system 444, an end effector 448, a paint level detecting system 452, one or more motors 456 configured to control a position of the R robots, and/or one or more actuators 458 configured to control movement of the paint applicator. The controller 434 may include a wireless interface 436 and an antenna 438 or a wired interface.

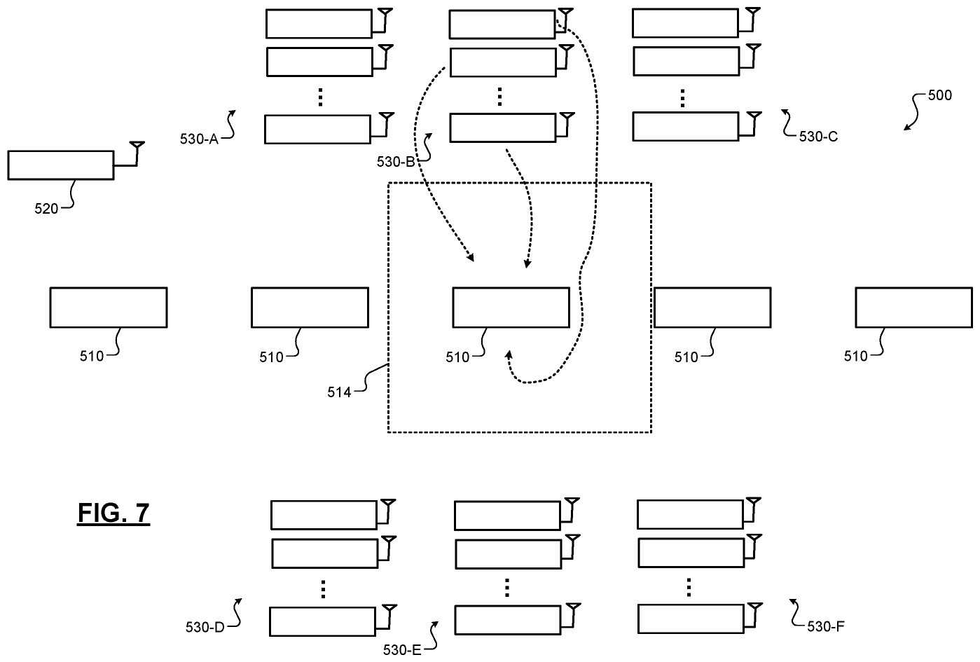

Referring now to FIG. 7, a painting system 500 includes one or more groups of robots 530-A, 530-B, 530-C, 530-D, 530-E, . . . , and 530-F. A controller 520 is configured to schedule the mobile robots 530 to paint a vehicle 510 in a paint area 514. Each of the groups of robots 530-A, 530-B, 530-C, 530-D, 530-E, . . . and 530-F includes a variable number of robots (e.g., X, Y, Z, R, S, T, respectively, where X, Y, Z, R, S, T are integers greater than zero). The number of robots in each group may depend on the popularity of the color, the number of robots needing repair, the number of robots that can work on the same vehicle at the same time, and/or other considerations.

For example, the mobile robots in the group 530-B are scheduled to paint a vehicle 510 in a paint area 514 with the color blue. The controller 520 determines the number of available robots that can paint the color blue and the number of robots to be used for the vehicle. The controller 520 divides the painting job into different portions that are assigned to two or more of the mobile robots that can paint the color blue. If one of the mobile robots in the group has a malfunction during the paint job, the controller reassigns the paint job to be performed by the malfunctioning mobile robot to another mobile robot in the group 530-B (if available) and/or redefines the paint jobs for one or more of the remaining robots in the group 530-B.

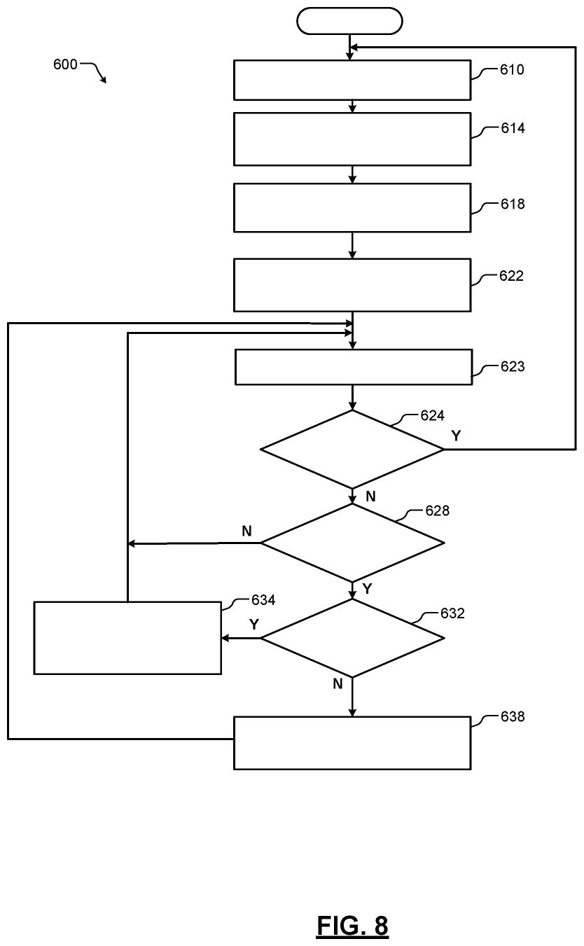

Referring now to FIG. 8, a method for operating a painting system including groups of robots with high transfer efficiency paint applicators is shown. At 610, the method determines the color of next vehicle to be painted. At 614, the method determines the number of mobile robots available to paint the vehicle the selected color. At 618, the method selects the number of mobile robots to be used. At 622, the method assigns different portions of the paint job to each of the selected mobile robots.

At 623, the mobile robots paint the vehicle. At 624, the method determines whether the paint job is finished for the vehicle. If 624 is true, the method returns to 610. If 624 is false, the method determines at 628 whether any of the mobile robots are disabled (e.g., due to lack of paint, a component failure, a fault, etc.). If 628 is true, the method determines whether additional mobile robots with the color for the current vehicle (e.g., blue) are available.

If 632 is true, the method assigns the portion of the paint job assigned to the disabled mobile robot to another mobile robot with the same color and/or reassigns one or more portions of the paint job to the remaining robots in the group at 634. If 632 is false, the method reassigns one or more portions of the paint job to the remaining robots in the group previously assigned to paint the vehicle at 638.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A painting system comprising:
a mobile robot including a frame, wheels connected to the frame, and a motor configured to move the wheels to position the mobile robot;
a paint container mounted on the mobile robot and configured to store paint; and
a robot arm including a first end mounted on the mobile robot and a paint applicator arranged at a second end of the robot arm,
wherein the paint applicator is in fluid communication with the paint container and includes one or more nozzles to spray the paint onto a surface.

2. The painting system of claim 1, wherein the paint applicator comprises one of an overspray-free paint applicator and a high transfer efficiency paint applicator.

3. The painting system of claim 1, wherein the surface corresponds to a surface of a vehicle.

4. The painting system of claim 1, wherein the mobile robot includes a controller configured to control movement of at least one of the mobile robot, the robot arm, and the paint applicator.

5. The painting system of claim 4, further comprising:
a vision guidance system configured to communicate with the controller, to take at least one of images and video of the surface, and to determine a position of at least one of the mobile robot, the robot arm, and the paint applicator based on the at least one of images and video of the surface,
wherein the controller positions the at least one of the mobile robot, the robot arm, and the paint applicator in response to the vision guidance system.

6. The painting system of claim 4, wherein the surface corresponds to a surface of a vehicle and further comprising an end effector configured to manipulate a component of the vehicle.

7. The painting system of claim 6, wherein the controller is configured to control a position of the end effector.

8. The painting system of claim 6, wherein the end effector includes an arm configured to move a swing panel of the vehicle.

9. The painting system of claim 4, wherein the paint applicator includes a plurality of nozzles and a plurality of actuators configured to adjust positions of the plurality of nozzles, respectively, relative to the paint applicator.

10. The painting system of claim 9, wherein the controller is configured to adjust positions of the plurality of actuators, respectively.

11. A painting system for a vehicle, comprising:
G groups of mobile robots each including a paint applicator, where G is an integer greater than zero, wherein each of the G groups includes two or more mobile robots configured to paint a respective one of G paint colors; and
a first controller configured to:
determine a first color of a first surface to be painted;
select R of the mobile robots in a first one of the G groups corresponding to the first color, where R is an integer greater than zero and less than or equal to G;
assign R portions of the first surface to the R mobile robots of the first one of the G groups, respectively; and
send R sets of instructions to the R mobile robots of the first one of the G groups, respectively, to paint the R portions of the first surface.

12. The painting system of claim 11, wherein the first controller is configured to communicate with the R mobile robots of the first one of the G groups during painting of the first surface and to at least one of:
replace at least one of the R mobile robots with another mobile robot from the first one of the G groups when the at least one of the R mobile robots has a malfunction; and
adjust at least one of the R portions of the first surface and send revised instructions based on the adjustment.

13. The painting system of claim 11, wherein the first controller is further configured to:
determine a second color of a second surface to be painted after the first surface, where the second color is different than the first color;
select S of the mobile robots of a second one of the G groups corresponding to the second color, where S is an integer greater than zero and less than or equal to G;
assign S portions of the second surface to be painted to the S mobile robots of the second one of the G groups; and
send S sets of instructions to the S mobile robots of the second one of the G groups, respectively, to paint S corresponding portions of the second surface.

14. The painting system of claim 11, wherein each of the mobile robots includes:
a frame;
wheels connected to the frame;
a motor configured to move the wheels to position the mobile robot;
a paint container mounted on the mobile robot and configured to store paint; and
a robot arm including a first end mounted on the mobile robot and a paint applicator arranged at a second end of the robot arm,
wherein the paint applicator is in fluid communication with the paint container and includes one or more nozzles to spray the paint onto the first surface.

15. The painting system of claim 11, wherein:
the paint applicator comprises one of an overspray-free paint applicator and a high transfer efficiency paint applicator, and
the first surface corresponds to a surface of a vehicle.

16. The painting system of claim 11, wherein the paint applicator includes a plurality of nozzles and a plurality of actuators configured to adjust positions of the plurality of nozzles, respectively.

17. The painting system of claim 14, wherein each of the mobile robots includes a second controller configured to control movement of at least one of the mobile robot, the robot arm, and the paint applicator.

18. The painting system of claim 17, further comprising:
a vision guidance system configured to communicate with the second controller, to take at least one of images and video of the first surface, and to determine a position of at least one of the mobile robot, the robot arm, and the paint applicator based on the at least one of images and video of the first surface,
wherein the second controller is configured to position the at least one of the mobile robot, the robot arm, and the paint applicator in response to the vision guidance system.

19. The painting system of claim 18, wherein:
the first surface corresponds to a surface of a vehicle and further comprising an end effector including an arm,
wherein the second controller is configured to control a position of the arm of the end effector to manipulate a swing panel of the vehicle.
